(19) United States
(12) Patent Application Publication
(10) Pub. No.: US 2022/0193905 A1
(43) Pub. Date: Jun. 23, 2022

(54) Door Opening Behavior

(71) Applicant: Boston Dynamics, Inc., Waltham, MA (US)

(72) Inventors: Stephen George Berard, Burlington, MA (US); Andrew James Barry, Cambridge, MA (US); Matthew David Malchano, Arlington, MA (US); Benjamin John Swilling, Winchester, MA (US); Alfred Anthony Rizzi, Waltham, MA (US)

(73) Assignee: Boston Dynamics, Inc., Waltham, MA (US)

(21) Appl. No.: 17/644,840

(22) Filed: Dec. 17, 2021

Related U.S. Application Data
(60) Provisional application No. 63/128,954, filed on Dec. 22, 2020.

(51) Int. Cl. B25J 9/16; B62D 57/032

(52) U.S. Cl. CPC B25J 9/1664; B62D 57/032

(57) ABSTRACT

Data processing hardware of a robot performs operations to identify a door within an environment. A robotic manipulator of the robot grasps a feature of the door on a first side facing the robot. When the door opens in a first direction toward the robot, the robotic manipulator exerts a pull force to swing the door in the first direction, a leg of the robot moves to a position that blocks the door from swinging in the second direction, the robotic manipulator contacts the door on a second side opposite the first side, and the robotic manipulator exerts a door opening force on the second side as the robot traverses a doorway corresponding to the door. When the door opens in a second direction away from the robot, the robotic manipulator exerts the door opening force on the first side as the robot traverses the doorway.

### CROSS REFERENCE TO RELATED APPLICATIONS

This application claims priority under 35 U.S.C. § 119(e) to U.S. Provisional Application 63/128,954, filed on Dec. 22, 2020. The disclosure of this prior application is considered part of the disclosure of this application and is hereby incorporated by reference in its entirety.

### TECHNICAL FIELD

This disclosure relates to door opening behavior for robots.

### BACKGROUND

A robot is generally defined as a reprogrammable and multifunctional manipulator designed to move material, parts, tools, or specialized devices through variable programmed motions for a performance of tasks. Robots may be manipulators that are physically anchored (e.g., industrial robotic arms), mobile robots that move throughout an environment (e.g., legs, wheels, or traction based mechanisms), or some combination of a manipulator and a mobile robot. Robots are utilized in a variety of industries including, for example, manufacturing, transportation, hazardous environments, exploration, and healthcare. As such, the ability of robots to traverse environments with obstacles are features requiring various means coordinated movement provide additional benefits to such industries SUMMARY

An aspect of the disclosure provides a computer-implemented method that, when executed by data processing hardware of a robot, causes the data processing hardware to perform operations. The operations include identifying at least a portion of a door within an environment about the robot. The robot includes a robotic manipulator. The operations further include controlling the robotic manipulator to grasp a feature of the door on a first side of the door facing the robot. The operations also include detecting whether the door opens by swinging in a first direction toward the robot or a second direction away from the robot. When the door opens by swinging in the first direction toward the robot, the operations include controlling the robotic manipulator to exert a pull force on the feature of the door to swing the door in the first direction from a first position to a second position. As the door swings in the first direction from the first position to the second position, the operations include instructing a leg of the robot to move to a position that blocks the door from swinging in the second direction toward the first position. When the leg is located in the position that blocks the door from swinging in the second direction, the operations include controlling the robotic manipulator to contact the door on a second side of the door opposite the first side of the door. When the door opens by swinging in the first direction toward the robot, the operations further include instructing the robotic manipulator to exert a door opening force on the second side of the door as the robot traverses a doorway corresponding to the door. When the door opens by swinging in the second direction away from the robot, the operations include instructing the robotic manipulator to exert the door opening force on the first side of the door as the robot traverses a doorway corresponding to the door.

When the door opens by swinging in the first direction toward the robot, after controlling the robotic manipulator to exert a pull force on the feature of the door to swing the door in the first direction from a first position to a second position, and as the door swings in the first direction from the first position to the second position, the operations may include instructing the robotic manipulator to move to a position that blocks the door from swinging in the second direction toward the first position. In other words, the robotic manipulator may exert a pull force on the feature of the door to swing the door and as the door swings, the robot may position an element that blocks the door from swinging back. The element that the robot positions to block the door may be a leg or it may be the robotic manipulator. When the robot positions the robotic manipulator to block the door, the robot first exerts the pull force on the feature on the first side of the door with the robotic manipulator to a degree significant enough to allow for time and/or space for the robot to then reposition the robotic manipulator at the second side of the door to prevent the door from swinging back in the opposite direction of the pull force. Thus, the robot, via the robotic manipulator, exerts the pull force on the first side of the door to swing the door in the first direction and then positions the robotic manipulator at the second side of the door to block the door from swinging in the second direction.

Aspects of the disclosure may provide one or more of the following optional features. In some implementations, when the door opens by swinging in the second direction away from the robot, the operations further include instructing the robot to traverse the doorway at a gait with a traversal speed. The traversal speed is based on the opening force being exerted on the first side of the door. In those implementations, the traversal speed may be based on (e.g., proportional) to an opening speed of the door caused by the door opening force being exerted on the first side of the door. In some examples, when the door opens by swinging in the second direction away from the robot, the operations further include maintaining a body alignment position for the robot along a centerline of the doorway corresponding to the door as the robot traverses the doorway corresponding to the door. In some embodiments, instructing the robotic manipulator to exert the door opening force on the first side of the door as the robot traverses a doorway corresponding to the door includes controlling the door opening force as a function of an angle of the door with respect to an orientation of the robot while the robot traverses the doorway. In some implementation, the robot is a quadruped.

In some examples, the operations further include instructing the robotic manipulator to cease exerting the door opening force when the robot clears a swing area associated with the door. In some embodiments, the operations further include receiving proprioceptive sensor data for the robot. In those embodiments, the operations further include determining the door opening force based on the received proprioceptive sensor data. In some implementations, controlling the robotic manipulator to contact the door on the second side of the door opposite the first side of the door further includes positioning the robotic manipulator to wrap around an edge of the door. In further implementations, positioning the robotic manipulator to wrap around the edge of the door includes positioning a first portion of the robotic manipulator along the edge of the door and positioning a second portion of the robotic manipulator to extend along the second side of the door.

Another aspect of the disclosure provides a robot. The robot includes a body, two or more legs coupled to the body, a robotic manipulator coupled to the body, data processing hardware, and memory hardware in communication with the data processing hardware. The memory hardware stores instructions that when executed on the data processing hardware cause the data processing hardware to perform operations. The operations include identifying at least a portion of a door within an environment about the robot. The operations further include controlling the robotic manipulator to grasp a feature of the door on a first side of the door facing the robot. The operations also include detecting whether the door opens by swinging in a first direction toward the robot or a second direction away from the robot. When the door opens by swinging in the first direction towards the robot, the operations include controlling the robotic manipulator to exert a pull force on the feature of the door to swing the door in the first direction from a first position to a second position. As the door swings in the first direction from the first position to the second position, the operations include instructing a respective leg among the two or more legs of the robot to move to a position that blocks the door from swinging in the second direction. When the respective leg is located in the position that blocks the door from closing, the operations include controlling the robotic manipulator to contact the door on a second side of the door opposite the first side of the door. When the door opens by swinging in the first direction towards the robot, the operations further include instructing the robotic manipulator to exert a door opening force on the second side of the door as the robot traverses a doorway corresponding to the door. When the door opens by swinging in the second direction away from the robot, the operations include instructing the robotic manipulator to exert the door opening force on the first side of the door as the robot traverses a doorway corresponding to the door.

Aspects of the disclosure may provide one or more of the following optional features. In some embodiments, when the door opens by swinging in the second direction away from the robot, the operations further include instructing the robot to traverse the doorway at a gait with a traversal speed. The traversal speed is based on the opening force being exerted on the first side of the door. In those embodiments, the traversal speed may be based on (e.g., proportional) to an opening speed of the door caused by the door opening force being exerted on the first side of the door. In some examples, when the door opens by swinging in the second direction away from the robot, the operations further include maintaining a body alignment position for the robot along a centerline of the doorway corresponding to the door as the robot traverses the doorway corresponding to the door. In some embodiments, instructing the robotic manipulator to exert the door opening force on the first side of the door as the robot traverses a doorway corresponding to the door includes controlling the door opening force as a function of an angle of the door with respect to an orientation of the robot while the robot traverses the doorway. In some implementations, the two or more legs include four legs.

In some examples, the operations further include instructing the robotic manipulator to cease exerting the door opening force when the robot clears a swing area associated with the door. In some implementations, the operations further include receiving proprioceptive sensor data for the robot and determining the door opening force based on the received proprioceptive sensor data. In some embodiments, controlling the robotic manipulator to contact the door on the second side of the door opposite the first side of the door further includes positioning the robotic manipulator to wrap around an edge of the door. In further embodiments, positioning the robotic manipulator to wrap around the edge of the door includes positioning a first portion of the robotic manipulator along the edge of the door and positioning a second portion of the robotic manipulator to extend along the second side of the door.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a perspective view of an example robot capable of door opening behaviors.

FIG. 1B is a schematic view of example systems of the robot of FIG. 1A.

FIGS. 2A-2C are schematic views of example door opening systems of the robot of FIG. 1A.

FIG. 2D is a schematic view of an example recovery manager for the door opening system of the robot of FIG. 1A.

FIG. 2E is a schematic view of an example door opening system of the robot of FIG. 1A.

FIG. 3 is a flowchart of an example arrangement of operations for a method of controlling the robot to open a door.

FIG. 4 is a schematic view of an example computing device that may be used to implement the systems and methods described herein.

Like reference symbols in the various drawings indicate like elements.

### DETAILED DESCRIPTION

As robots move about environments, robots may often encounter structures that require a particular behavior or set of behaviors to successfully interact with the structure. One type of structure that requires some degree of interaction is a door. Doors are commonplace in the human landscape. Doors may serve as an entry to a particular space or an exit from a particular place. Often, doors function as a movable barrier that may contain one area or close one area off from another. Since doors are so ubiquitous to the human environment, robots, particularly, mobile robots, are likely to need to understand how to navigate a door within its environment. For instance, when a robot moves from an outdoor space to an indoor space, a robot is likely to come across a door separating these spaces. Similarly, a robot may move about an indoor space while performing tasks and need to move one or more doors in order to navigate through the indoor space.

Unfortunately, a robot does not naturally possess the knowledge and coordination of a human to interact with a door without programming. Since humans are familiar with doors, a human is able to quickly recognize a door (e.g., by its features, such as a handle/door knob, hinges, its framing) and use aspects of human coordination to move the door as necessary. For example, a human realizes that a door is heavy or light or that he or she will need to provide the door with clearance to open before he or she is able to move through the door. Moreover, a human appreciates that a door may or may not automatically close when released or that there is some degree of urgency to move through the swing space of the door. Without these natural tendencies, a robot needs systems and methods to coordinate its behavior when it encounters a door to ensure that a door does not become an obstacle that impedes the performance of the robot.

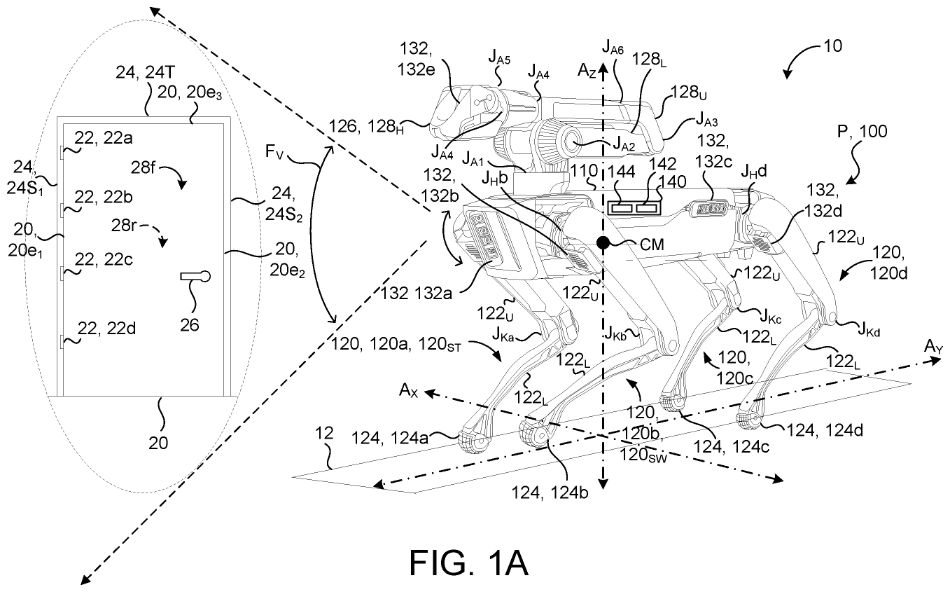

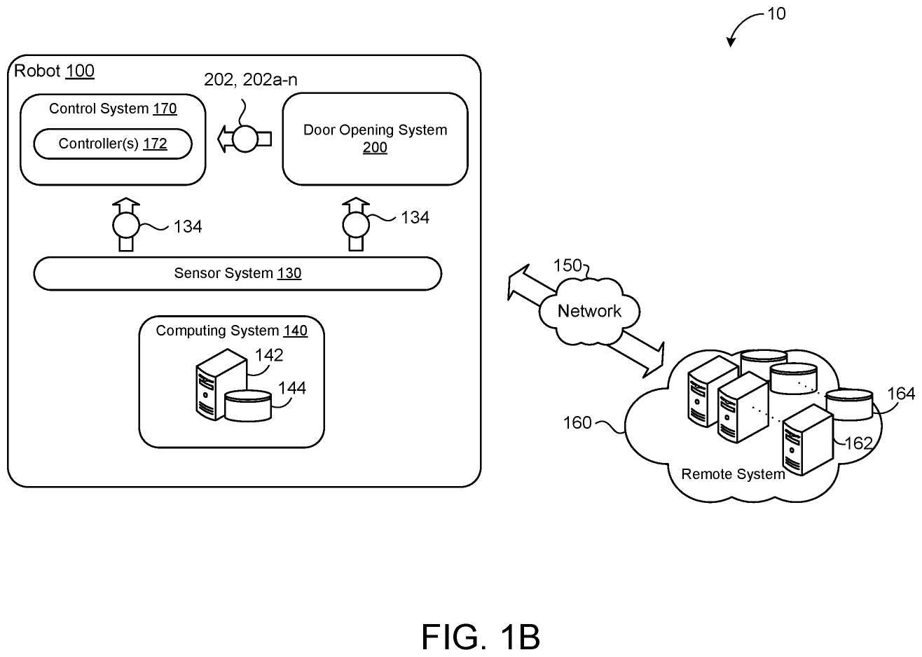

FIG. 1A is an example of an environment 10 for a robot 100. The environment 10 generally refers to a spatial area associated with some type of terrain that includes a door 20. For instance, FIG. 1A illustrates the door 20 in the field of view Fv of a sensor (e.g., sensor 132, 132e) mounted on robot 100. As the robot 100 approaches a door 20, the robot 100 may engage in a behavior or set of behaviors coordinated by the door opening system 200. Door opening system 200 may use various systems of the robot 100 to interact with the door 20.

A door 20 generally refers to a movable structure that provides a barrier between two adjoining spaces. While there may be different types of doors 20, often doors 20 move by either pivoting about their hinges 22 or sliding along a track associated with the door 20. As a door 20 moves, the door 20 may have a range of motion between a completely closed state where the door 20 is referred to as closed and a completely open state where the door 20 no longer occupies a frame 24 of the door 20. For a hinged door 20, one or more hinges 22 (e.g., shown as four hinges 22, 22a-d) coupled to the door 20 are also secured to a portion of the frame 24 referred to as a side jamb. Generally speaking, a frame 24 for a door 20 includes a head jamb 24, 24T that refers to a top horizontal section spanning a width of the frame 24 and a side jamb 24, 24S_{1,2} on each side of the door 20 where each side jamb 24S spans a height of the door 20 and extends along a vertical edge 20, 20e_{1,2} of the door 20. When a door 20 pivots about its hinges 22 from the completely closed state to the completely open state, the door 20 sweeps a space referred to as a swing area SA. In other words, if an object was located in the swing area SA, the door 20 may collide with the object as the door 20 pivots about its hinges 22 and swings through some portion of its range of motion.

A door 20 also typically includes a door feature 26 (also referred to as feature 26) that is configured to assist with moving the door 20 between the open state and/or the closed state. In some configurations, the feature 26 includes graspable hardware, such as a handle, mounted to a face (i.e., surface) of the door 20 (e.g., the front surface 28f and/or the rear surface 28r opposite the front surface 28f). The feature 26, such as a handle, may also include a latching mechanism that allows the door 20 to latch to or to unlatch from the frame 24 of the door 20. In other words, actuating the handle 26 (e.g., turning, rotating, or some other movement applied to the handle 26) may unlatch the door 20 from the frame 24 and allow the door 20 to open. The latching mechanism therefore may serve as a securement means for the door 20 such that the door 20 may be locked/unlocked or resist opening without purposeful actuation.

Referring to FIGS. 1A and 1B, the robot 100 includes a body 110 with locomotion-based structures such as legs 120a-d coupled to the body 110 that enable the robot 100 to move about the environment 10. In some examples, each leg 120 is an articulable structure such that one or more joints J permit members 122 of the leg 120 to move. For instance, each leg 120 includes a hip joint J_{H} coupling an upper member 122, 122_{U} of the leg 120 to the body 110 and a knee joint J_{K} coupling the upper member 122_{U} of the leg 120 to a lower member 122_{L} of the leg 120. Although FIG. 1A depicts a quadruped robot with four legs 120a-d, the robot 100 may include any number of legs or locomotive-based structures (e.g., a biped or humanoid robot with two legs, or other arrangements of one or more legs) that provide a means to traverse the terrain within the environment 10.

In order to traverse the terrain, each leg 120 has a distal end 124 that contacts a surface of the terrain (i.e., a traction surface). In other words, the distal end 124 of the leg 120 is the end of the leg 120 used by the robot 100 to pivot, plant, or generally provide traction during movement of the robot 100. For example, the distal end 124 of a leg 120 corresponds to a foot of the robot 100. In some examples, though not shown, the distal end 124 of the leg 120 includes an ankle joint J_{A} such that the distal end 124 is articulable with respect to the lower member 122_{L} of the leg 120.

In the examples shown, the robot 100 includes an arm 126 that functions as a robotic manipulator. The arm 126 may be configured to move about multiple degrees of freedom (e.g., six degrees of freedom plus the freedom of the hand member 128H) in order to engage elements of the environment 10 (e.g., objects within the environment 10). In some implementations, the arm 126 connects to the robot 100 at a socket on the body 110 of the robot 100. In some configurations, the socket is configured as a connector such that the arm 126 may attach or detach from the robot 100 depending on whether the arm 126 is needed for operation. In some examples, the arm 126 includes one or more members 128, where the members 128 are coupled by joints J such that the arm 126 may pivot or rotate about the joint(s) J. For instance, with more than one member 128, the arm 126 may be configured to extend or to retract. To illustrate an example, FIG. 1A depicts the arm 126 with three members 128 corresponding to a lower member 128_{L}, an upper member 128_{U}, and a hand member 128_{H} (e.g., also referred to as an end-effector 128_{H}). Here, the lower member 128_{L} may rotate or pivot about one or more arm joints J_{A} located adjacent to the body 110 (e.g., where the arm 126 connects to the body 110 of the robot 100). For example, FIG. 1A depicts the arm 126 able to rotate about a first arm joint J_{A1} or yaw arm joint. With a yaw arm joint, the arm 126 is able to rotate in 360 degrees (or some portion thereof, e.g., 330 degrees) axially about a vertical gravitational axis (e.g., shown as Az) of the robot 100. The lower member 128_{L} may pivot (e.g., while rotating) about a second arm joint J_{A2} (e.g., rotate about an axis extending in an x-direction axis Ax). For instance, the second arm joint J_{A2} allows the arm 126 to pitch to a particular angle (e.g., raising or lowering one or more members 128 of the arm 126).

Additionally, the lower member 128_{L} may be coupled to the upper member 128_{U} at a third arm joint J_{A3}. The third arm joint J_{A3}, like the second arm joint J_{A2}, may allow the upper member 128U to move or to pivot relative to the lower member 128U some degree of rotation (e.g., up to 180 degrees of rotation about an axis extending in the x-direction axis Ax). In some configurations, the ability of the arm 126 to pitch about the second arm joint J_{A2} and/or the third arm joint J_{A3} allows the arm 126 to extend or to retract one or more members 128 of the arm 126 some length/distance. For example, FIG. 1A depicts the arm 126 with the upper member 128U disposed on the lower member 128L such that the hand member 128H extends some distance forward of the first arm joint J_{A1}. If both of the lower member 128L and the upper member 128U pitch about the second arm joint J_{A2} and the third arm joint J_{A3} respectively, the hand member 128H may extend to a distance forward of the first arm joint J_{A1} that ranges from some length of the hand member 128H (e.g., as shown) to about a combined length of each member 128 (e.g., the hand member 128H, the upper member 128U, and the lower member 128L).

In some implementations, the hand member 128H is coupled to the upper member 128U at a fourth arm joint J_{A4} that permits the hand member 128H to pivot like a wrist joint in human anatomy. For example, the fourth arm joint J_{A4} enables the hand member 128H to rotate about the vertical gravitational axis (e.g., shown as A_{Z}) some degree of rotation (e.g., up to 210 degrees of rotation). The hand member 128H may also include another joint J that allows the hand member 128H to swivel (e.g., also referred to as a twist joint) with respect to some other portion of the arm 126 (e.g., with respect to the upper member 128U). In other words, as shown in FIG. 1A, a fifth arm joint J_{A5} may allow the hand member 128H to rotate about a longitudinal axis of the hand member 128H (e.g., up to 330 degrees of twisting rotation).

In some implementations, the arm 126 additionally includes a second twist joint depicted as a sixth joint J_{A6}. The sixth joint J_{A6} may be located near the coupling of the lower member 128_{L} to the upper member 128_{U} and function to allow the upper member 128_{U} to twist or rotate relative to the lower member 128_{L}. In other words, the sixth joint J_{A6} may function as a twist joint similarly to the fifth joint J_{A5} or wrist joint of the arm 126 adjacent the hand member 128_{H}. For instance, as a twist joint, one member coupled at the joint J may move or rotate relative to another member coupled at the joint J (e.g., a first member coupled at the twist joint is fixed while the second member coupled at the twist joint rotates).

In some examples, such as FIG. 1A, the hand member 128_{H} or end-effector 128_{H} is a mechanical gripper that includes a one or more moveable jaws configured to perform different types of grasping of elements within the environment 10. In the example shown, the end-effector 128_{H} includes a fixed first jaw and a moveable second jaw that grasps objects by clamping the object between the jaws. The moveable jaw is configured to move relative to the fixed jaw in order to move between an open position for the gripper and a closed position for the gripper (e.g., closed around an object).

The robot 100 has a vertical gravitational axis (e.g., shown as a Z-direction axis A_{Z}) along a direction of gravity, and a center of mass CM, which is a position that corresponds to an average position of all parts of the robot 100 where the parts are weighted according to their masses (i.e., a point where the weighted relative position of the distributed mass of the robot 100 sums to zero). The robot 100 further has a pose P based on the CM relative to the vertical gravitational axis A_{Z} (i.e., the fixed reference frame with respect to gravity) to define a particular attitude or stance assumed by the robot 100. The attitude of the robot 100 can be defined by an orientation or an angular position of the robot 100 in space. Movement by the legs 120 relative to the body 110 alters the pose P of the robot 100 (i.e., the combination of the position of the CM of the robot and the attitude or orientation of the robot 100). Here, a height generally refers to a distance along the z-direction (e.g., along a z-direction axis A_{Z}). The sagittal plane of the robot 100 corresponds to the Y-Z plane extending in directions of a y-direction axis A_{Y} and the z-direction axis A_{Z}. In other words, the sagittal plane bisects the robot 100 into a left and a right side. Generally perpendicular to the sagittal plane, a ground plane (also referred to as a transverse plane) spans the X-Y plane by extending in directions of the x-direction axis A_{X} and the y-direction axis A_{Y}. The ground plane refers to a ground surface 12 where distal ends 124 of the legs 120 of the robot 100 may generate traction to help the robot 100 move about the environment 10. Another anatomical plane of the robot 100 is the frontal plane that extends across the body 110 of the robot 100 (e.g., from a left side of the robot 100 with a first leg 120a to a right side of the robot 100 with a second leg 120b). The frontal plane spans the X-Z plane by extending in directions of the x-direction axis A_{X} and the z-direction axis A_{z}.

In order to maneuver about the environment 10 or to perform tasks using the arm 126, the robot 100 includes a sensor system 130 with one or more sensors 132, 132a-n. For instance, FIG. 1A illustrates a first sensor 132, 132a mounted at a head of the robot 100, a second sensor 132, 132b mounted near the hip of the second leg 120b of the robot 100, a third sensor 132, 132c corresponding one of the sensors 132 mounted on a side of the body 110 of the robot 100, a fourth sensor 132, 132d mounted near the hip of the fourth leg 120d of the robot 100, and a fifth sensor 132, 132e mounted at or near the end-effector 128_{H} of the arm 126 of the robot 100. The sensors 132 may include vision/image sensors, inertial sensors (e.g., an inertial measurement unit (IMU)), force sensors, and/or kinematic sensors. Some examples of sensors 132 include a camera such as a stereo camera, a time-of-flight (TOF) sensor, a scanning light-detection and ranging (LIDAR) sensor, or a scanning laser-detection and ranging (LADAR) sensor. In some examples, the sensor 132 has a corresponding field(s) of view Fv defining a sensing range or region corresponding to the sensor 132. For instance, FIG. 1A depicts a field of a view Fv for the robot 100. Each sensor 132 may be pivotable and/or rotatable such that the sensor 132 may, for example, change the field of view Fv about one or more axis (e.g., an x-axis, a y-axis, or a z-axis in relation to a ground plane).

When surveying a field of view Fv with a sensor 132, the sensor system 130 generates sensor data 134 (also referred to as image data) corresponding to the field of view Fv. The sensor system 130 may generate the field of view Fv with a sensor 132 mounted on or near the body 110 of the robot 100 (e.g., sensor(s) 132a, 132b). The sensor system may additionally and/or alternatively generate the field of view Fv with a sensor 132 mounted at or near the end-effector 128_{H} of the arm 126 (e.g., sensor(s) 132c). The one or more sensors 132 may capture sensor data 134 that defines the three-dimensional point cloud for the area within the environment 10 about the robot 100. In some examples, the sensor data 134 is image data that corresponds to a three-dimensional volumetric point cloud generated by a three-dimensional volumetric image sensor 132. Additionally or alternatively, when the robot 100 is maneuvering about the environment 10, the sensor system 130 gathers pose data for the robot 100 that includes inertial measurement data (e.g., measured by an IMU). In some examples, the pose data includes kinematic data and/or orientation data about the robot 100, for instance, kinematic data and/or orientation data about joints J or other portions of a leg 120 or arm 126 of the robot 100. With the sensor data 134, various systems of the robot 100 may use the sensor data 134 to define a current state of the robot 100 (e.g., of the kinematics of the robot 100) and/or a current state of the environment 30 about the robot 100.

In some implementations, the sensor system 130 includes sensor(s) 132 coupled to a joint J. Moreover, these sensors 132 may couple to a motor M that operates a joint J of the robot 100 (e.g., sensors 132, 132b-d). Here, these sensors 132 generate joint dynamics in the form of joint-based sensor data 134. Joint dynamics collected as joint-based sensor data 134 may include joint angles (e.g., an upper member 122_{U} relative to a lower member 122_{L} or hand member 126_{H} relative to another member of the arm 126 or robot 100), joint speed, joint angular velocity, joint angular acceleration, and/or forces experienced at a joint J (also referred to as joint forces). Joint-based sensor data generated by one or more sensors 132 may be raw sensor data, data that is further processed to form different types of joint dynamics, or some combination of both. For instance, a sensor 132 measures joint position (or a position of member(s) 122 coupled at a joint J) and systems of the robot 100 perform further processing to derive velocity and/or acceleration from the positional data. In other examples, a sensor 132 is configured to measure velocity and/or acceleration directly.

As the sensor system 130 gathers sensor data 134, a computing system 140 stores, processes, and/or communicates the sensor data 134 to various systems of the robot 100 (e.g., the computing system 140, the control system 170, and/or the door opening system 200). In order to perform computing tasks related to the sensor data 134, the computing system 140 of the robot 100 includes data processing hardware 142 and memory hardware 144. The data processing hardware 142 is configured to execute instructions stored in the memory hardware 144 to perform computing tasks related to activities (e.g., movement and/or movement based activities) for the robot 100. Generally speaking, the computing system 140 refers to one or more locations of data processing hardware 142 and/or memory hardware 144.

In some examples, the computing system 140 is a local system located on the robot 100. When located on the robot 100, the computing system 140 may be centralized (i.e., in a single location/area on the robot 100, for example, the body 110 of the robot 100), decentralized (i.e., located at various locations about the robot 100), or a hybrid combination of both (e.g., where a majority of centralized hardware and a minority of decentralized hardware). To illustrate some differences, a decentralized computing system 140 may allow processing to occur at an activity location (e.g., at motor that moves a joint of a leg 120) while a centralized computing system 140 may allow for a central processing hub that communicates to systems located at various positions on the robot 100 (e.g., communicate to the motor that moves the joint of the leg 120).

Additionally or alternatively, the computing system 140 includes computing resources that are located remotely from the robot 100. For instance, the computing system 140 communicates via a network 150 with a remote system 160 (e.g., a remote server or a cloud-based environment). Much like the computing system 140, the remote system 160 includes remote computing resources, such as remote data processing hardware 162 and remote memory hardware 164. Here, sensor data 134 or other processed data (e.g., data processing locally by the computing system 140) may be stored in the remote system 160 and may be accessible to the computing system 140. In additional examples, the computing system 140 is configured to utilize the remote resources 162, 164 as extensions of the computing resources 142, 144 such that resources of the computing system 140 may reside on resources of the remote system 160.

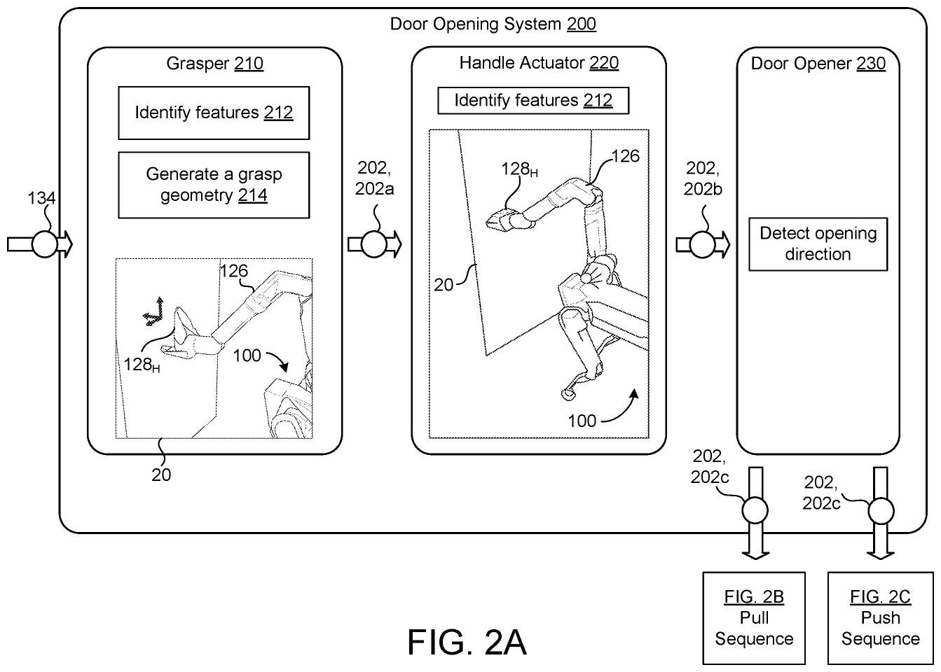

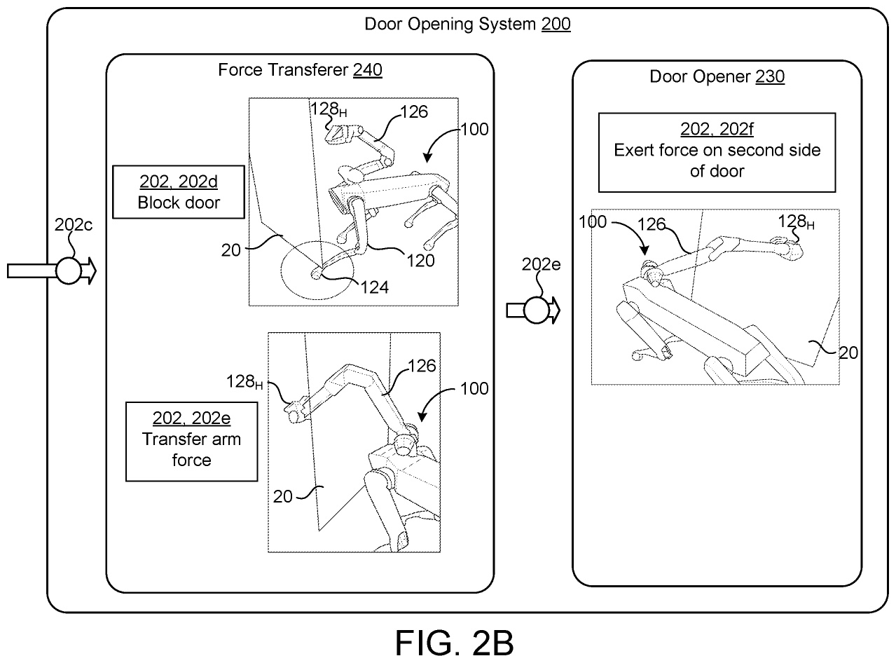

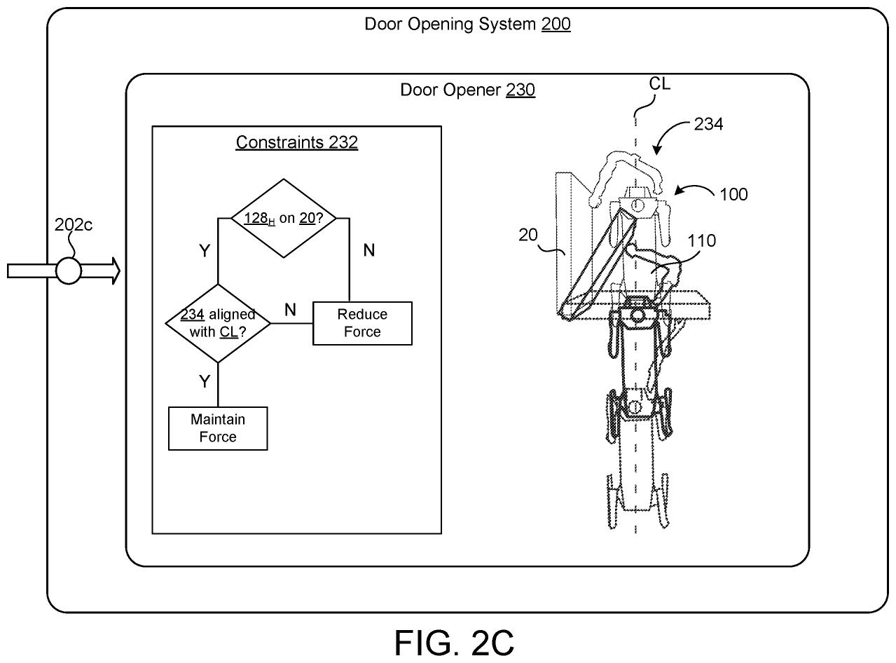

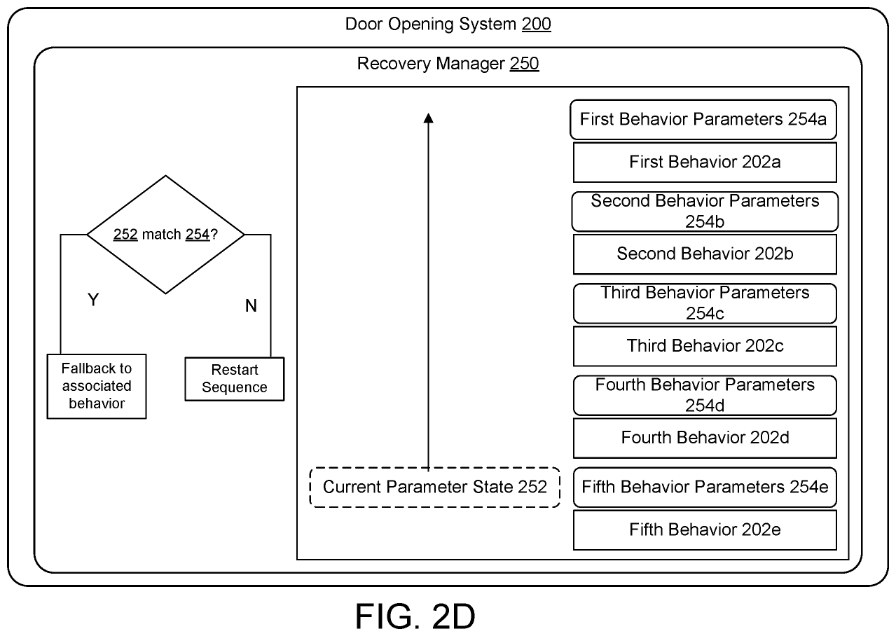

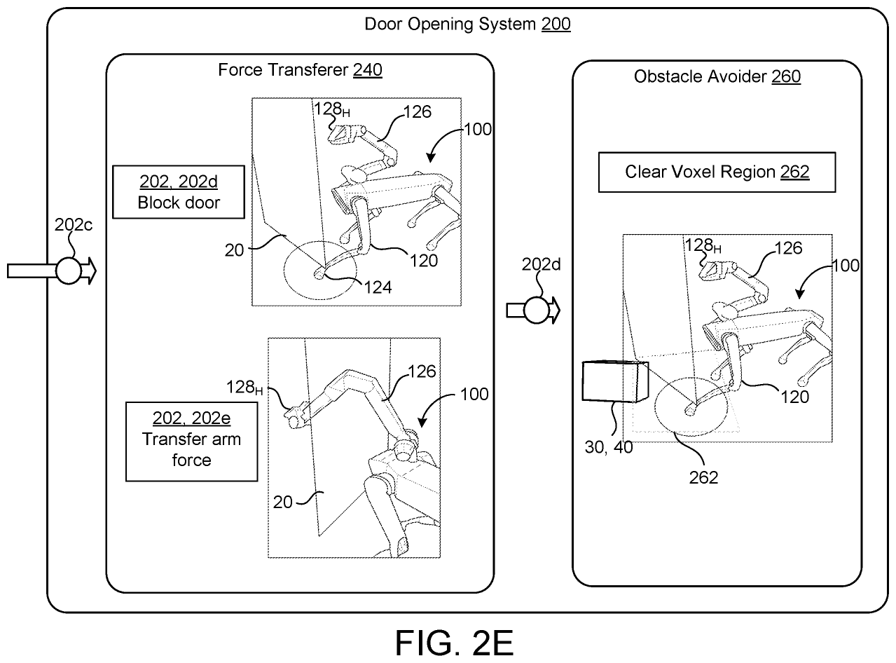

In some implementations, as shown in FIG. 1B, the robot 100 includes a control system 170. The control system 170 may be configured to communicate with systems of the robot 100, such as the at least one sensor system 130 and the door opening system 200. As described in greater detail below with reference to FIGS. 2A-2D, the door opening system 200 may operate in conjunction with the control system 170 such that one or more controllers 172 receive, among a set of door opening behaviors (or actions) 202, 202a-n, each behavior 202 or action from the door opening system 200 and control the robot to perform 100 to perform the particular behavior 202 (e.g., as shown in FIG. 1).

The control system 170 may perform operations and other functions using hardware 140. The control system 170 includes at least one controller 172 that is configured to control the robot 100. For example, the controller 172 controls movement of the robot 100 to traverse about the environment 10 based on input or feedback from the systems of the robot 100 (e.g., the sensor system 130, the control system 170, and/or the door opening system 200). In additional examples, the controller 172 controls movement between poses and/or behaviors of the robot 100. At least one the controller 172 may be responsible for controlling movement of the arm 126 of the robot 100 in order for the arm 126 to perform various tasks using the end-effector 128_{H}. For instance, at least one controller 172 controls the end-effector 128_{H} (e.g., gripper) to manipulate an object or element (i.e., a door 20 or door feature 26) in the environment 10. For example, the controller 172 actuates the movable jaw in a direction towards the fixed jaw to close the gripper. In other examples, the controller 172 actuates the movable jaw in a direction away from the fixed jaw to open the gripper.

In some examples, one or more controllers 172 responsible for controlling movement of the arm 126 may coordinate with the door opening system 200 in order to sense or to generate sensor data 134 when the robot 100 encounters a door 20. For instance, if the robot 100 is informed that there is a door 20 within its vicinity (e.g., by an operator of the robot 100) or recognizes a door 20 within its vicinity, the controller 172 may manipulate the arm 126 to gather sensor data 134 about features of the door 20 (e.g., information about the feature (e.g., handle) 26 of the door 20) and/or a current state of the door 20.

A given controller 172 may control the robot 100 by controlling movement about one or more joints J of the robot 100. In some configurations, the given controller 172 is software with programming logic that controls at least one joint J or a motor M which operates, or is coupled to, a joint J. For instance, the controller 172 controls an amount of force that is applied to a joint J (e.g., torque at a joint J). As programmable controllers 172, the number of joints J that a controller 172 controls is scalable and/or customizable for a particular control purpose. A controller 172 may control a single joint J (e.g., control a torque at a single joint J), multiple joints J, or actuation of one or more members 128 (e.g., actuation of the hand member 128_{H}) of the robot 100. By controlling one or more joints J, actuators or motors M, the controller 172 may coordinate movement for all different parts of the robot 100 (e.g., the body 110, one or more legs 120, the arm 126). For example, to perform some movements or tasks, a controller 172 may be configured to control movement of multiple parts of the robot 100 such as, for example, two legs 120a-b, four legs 120a-d, or two legs 120a-b combined with the arm 126.

Referring now to FIG. 1B, the sensor system 130 of the robot 100 generates a three-dimensional point cloud of sensor data 134 for an area within the environment 10 about the robot 100. The sensor data 134 corresponds to the current field of view Fv of the one or more sensors 132 mounted on the robot 100. In some examples, the sensor system 130 generates the field of view Fv with the one or more sensors 132e mounted at or near the end-effector 128_{H}. In other examples, the sensor system 130 additionally and/or alternatively generates the field of view Fv based on the one or more sensors 132a, 132b mounted at or near the body 110 of the robot 100. The sensor data 134 updates as the robot 100 maneuvers within the environment 10 and the one or more sensors 132 are subject to different field of views Fv. The sensor system 130 sends the sensor data 134 to the computing system 140, the control system 170, and/or the door opening system 200.

The door opening system 200 is a system of the robot 100 that communicates with the sensor system 130 and the control system 170 to specify behaviors for the robot 100 to open a door 20 in the environment 10 (also referred to as a sequence of door opening behaviors). In this sense, the door opening system 200 may refer to a sequence of actions or behaviors that coordinate the limbs 120, 126 and the body 110 of the robot 100 to open a door 20 and to traverse a space previously occupied by the door 20 while the door 20 is open. The door opening system 200 is configured to receive sensor data 134 to locate the door 20 and/or features of the door 20 (e.g., the handle 26 of the door 20). The sensor data 134 received by the door opening system 200 may correspond to proprioceptive sensor data 134 that enables the door opening system 200 to estimate a state of the door 20 (e.g., based on the impact that the door 20 is having on measurements internal to the robot 100). For instance, the sensor data 134 allows the door opening system 200 to generate a model for the door 20 that the door opening system 200 may use to open the door 20. During the sequence of door opening behaviors, the door opening system 200 may also use sensor data 134 collected during the door opening sequence of behaviors to allow the arm 126 to intelligently engage with the door 20 throughout the door opening process. For example, the sensors 132 may provide force feedback for interactions that the robot 100 has with the door 20. More particularly, the sensor data 134 from the sensors 132 may inform the door opening system 200 as to force-based interactions with the door 20 such as actuating the handle 26 and pulling/pushing the door 20 to an open state (or closed state).

To provide an accurate account of the robot's forces and interactions with the door 20, the door opening system 200 may receive the sensor data 134 from one or more sensors 132 mounted on the end-effector 128_{H} (e.g., directly mounted on the end-effector 128_{H}). By receiving data 134 from sensors 132 mounted at or near the location of interaction with the door 20, the sensor data 134 may generally be more accurate. For instance, sensor data 134 from a sensor 132 of the end-effector 128_{H} may require less interpretation than sensor data 134 from a sensor 132 further from an interaction site between the robot 100 and the door 20. In other words, the information is directly from the source. Although it may be more convenient to have sensors 132 generating sensor data 134 near or at the interaction site (i.e., a location where the robot 100 interacts with the door 20), the door opening system 200 may derive similar sensor information from sensors 132 located elsewhere on the robot 100 (e.g., located on the body 110 of the robot 100). For instance, the door opening system 200 may use sensor data 134 gathered by one or more sensors 132 mounted on the body 110 of the robot 100. When using sensors 132, such as these sensors 132 mounted on the body 110 of the robot 100, this indirect sensing approach often requires precise calibration of the sensors 132 relative to the arm 126 and/or end-effector 128_{H} to ensure the kinematic relationships and dynamic variables accurately reflect the robot's interaction with the door 20. Comparatively speaking, the direct sensing approach (i.e., generating sensor data 134 at the interaction site) removes some of the potential inaccuracies of the indirect sensing approach even though both techniques deliver usable information to the door opening system 200.

As the robot 100 navigates the environment 10 (e.g., without information or indication from an operator), the robot 100 may not have any information regarding the presence of doors 20 within the environment 10. Meaning that, the robot 100 is without any apriori information regarding one or more doors 20 within the environment 10. Since the robot 100 does not have any information about the doors 20 that may be present in the environment 10, the door opening system 200 is generally configured with the expectation that it will have to identify a door 20 and to subsequently interact with the door 20 if necessary. In some examples, an operator or a user of the robot 100 may use a remote controller or some other means of communicating with the robot 100 to provide some type of indication that a door 20 is present in a particular vicinity about the robot 100. In other words, a human operator of the robot 100 may provide a hint to the robot 100 that a door 20 exists in the spatial environment 10 about the robot 100. This hint, however, may not provide any further details about the door 20 or features of the door 20 (i.e., merely that a door 20 exists/is present in the environment 10). Based on its own recognition or using a hint from an operator, the robot 100 may approach the door 20 in order to allow the door opening system 200 to learn information and/or features about the door 20. For example, the robot 100 moves to a position in order to stand in front of the door 20 and uses the sensor(s) 132 associated with the robot's end-effector 126_{H} (and/or other sensors 132 of the robot 100) to produce sensor data 130 for the door 20. In some examples, the robot 100 includes a sensor 132 (e.g., a TOF sensor 132 at the end-effector 128_{H}) that generates three dimensional point cloud data for the door 20. With the sensor data 134 gathered by the robot 100 about the door 20, the door opening system 200 may identify features of the door 20.

In some implementations, the robot 100 may be provided with one or more maps that define the location of one or more doors 20 in a particular environment 10. For example, the robot 100 may receive a schematic of a building that defines the locations of doors 20 within the building and may integrate the information from the schematic into one or more navigational maps generated by the robot 100 (e.g., a mapping system or perception system of the robot 100). In other configurations, the robot 100 may be configured with image classification algorithms that receive the sensor data 134 from the sensor system 130 of the robot 100 and classify one or more doors 20 that appear to be present in the environment 10 based on the data 134.

In some examples, the robot 100 configures its mapping systems for a particular environment 10 by performing a setup run of the environment 10 where the robot 100 may drive or navigate through the environment 10. While navigating through the environment 10 on the setup run, the robot 100 may also be gathering information that may be used to identify doors 20 within the environment 10. In some examples, an operator guides the robot 100 through this setup run. Here, the operator may take the setup run as the opportunity to indicate to the robot 100 where doors 20 exist within the environment 10. In some examples, during the setup run, when the operator indicates that a door 20 is present in a particular location, the robot 100 may be configured to approach the door 20 and gather further information regarding the door 20. For instance, the robot 100 gathers three-dimensional sensor data 134 for the door 20 in order to define features of the door 20 such as door edges 20e, the handle 26 for the door 20, the door's spatial relationship to other nearby objects, etc. With this approach, when the robot 100 subsequently performs a mission or task in the environment 10 with a known door 20, the robot 100 may be able to begin at a later behavior in the door opening sequence that skips prior behavior(s) that may gather information regarding the door 20.

Referring to FIGS. 2A-2D, the door opening system 200 generally includes a grasper 210, a handle actuator 220, a door opener 230, and a force transferor 240. These components 210, 220, 230, 240 of the door opening system 200 may collectively perform the sequence of behaviors that the robot 100 uses to open a door 20 within the environment 10. The sequence of behaviors may vary depending on whether the sequence corresponds to push door sequence or a pull door sequence. Here, a push door sequence corresponds to a sequence where, to open the door 20, the robot 100 must push the door 20 in a direction where the door 20 swings away from the robot 100. In contrast, a pull door sequence corresponds to a sequence where, to open the door 20, the robot 100 has to pull the door 20 in a direction towards the robot 100 such that the door 20 swings towards the robot 100. Notably, some differences between these sequences are: (i) the initial direction of force that the arm 126 (e.g., the end-effector 128_{H}) exerts on the handle 26 of the door 20 or the door 20 itself, and (ii) when the door 20 opens in a direction towards the robot 100, the robot 100 must navigate around the door 20 to prevent the door 20 from colliding with robot 100. Often, whether the door 20 demands a push sequence or a pull sequence depends on how the door 20 is able to move (e.g., how the door 20 is mounted on the hinges 22) relative to the position of the robot 100 when the robot 100 encounters the door 20. For instance, a door 20 may swing from a first room into a second room to open. If the robot 100 approached the door 20 traveling from the first room to the second room, the door 20 would require a push sequence to open. Whereas, if the robot 100 approached the door 20 traveling from the second room to the first room, the door 20 would require a pull sequence to open. To execute either sequence of behaviors, the door opening system 200 may include its own dedicated controllers 172 (e.g., one or more dedicated controller 172 to each component of the door opening system 200) or work in conjunction with the controller system 170 to use one or more controllers 172 capable of performing other non-door opening behaviors for the robot 100.

Each component 210, 220, 230, 240 of the door opening system 200 may perform one or more behaviors 202, 202a-n or actions of a door opening sequence in order to progress the robot 100 through the entire sequence of behaviors that open the door 20. Here, the door opening system 200 may operate in conjunction with the control system 170 such that one or more controllers 172 receive each behavior 202 or action and control the particular behavior 202 (e.g., as shown in FIG. 1). In some configurations, each component 210, 220, 230, 240 is programmed to be its own feedback controller that coordinates and/or controls the behaviors 202 that it performs.

The grasper 210 is configured to identify the door 20 within the environment 10 about the robot 100. In some examples, the grasper 210 identifies the door 20 based on sensor data 134. In some configurations, the grasper 210 receives sensor data 134 that corresponds to a three-dimensional point cloud of the door 20 and, based on the sensor data 134, the grasper 210 identifies features of the door 20 and/or models a current state of the door 20. In some implementations, the door opening system 200 receives an indication that a door 20 (e.g., from an operator of the robot 100, from an image classifying system of the robot, and/or from a perception/mapping system of the robot 100) is located at a particular location within the environment 10. Upon receiving the indication, the robot 100 may move and/or reposition itself in a door opening stance position in front of the door 20. In the door opening stance position, the sensors 132 of the robot 100 are able to provide a field of view Fv of the door 20 that the sensor data 134 captures and relays to the door opening system 200. The robot 100 may also gather the sensor data 134 for the door 20 by moving around in the vicinity adjacent to the door 20. In some examples, the robot 100 gathers sensor data 134 for the door 20 by modifying an orientation of the body 110 of the robot 100 (e.g., by pitching the body 110, rolling the body 110, and/or yawing the body 110). Additionally or alternatively, the arm 126 of the robot 100 includes sensor(s) 132 (e.g., TOF sensor(s)) such that the robot 100 may scan the location that the door opening system 200 receives as the indication for where the door 20 is located within the environment 10. For example, by using the arm 126 as a means of sensing, the door opening system 200 may receive fine-grained sensor data 134 that may more accurately estimate the location of features 212 of the door 20.

Based on the sensor data 134 corresponding to the door 20, the grasper 210 identifies features 212 of the door 20. Here, the features 212 of the door 20 may include the handle 26 of the door 20, one or more edges 20e of the door 20, the hinges 22 of the door 20, or other characteristics common to a door 20. From the identified features 212, the grasper 210 has some spatial understanding of the spatial location of the handle 26 of the door 20 relative to the robot 100 and/or the door 20. In other words, from the sensor data 134, the grasper 210 determines the location of the handle 26 of the door 20. In some examples, since the sensor data 134 corresponds to a three-dimensional point cloud data, the grasper 210 is also able to determine a geometry or shape of the handle 26 to generate a grasp geometry 214 for the handle 26 of the door 20. Here, the grasp geometry 214 refers to a geometry of an object used to plan a grasping pose for an end-effector 126_{H} to successfully engage with the object. In this situation, the object is the handle 26 of the door 20 to enable the door opening process to proceed along the sequence of behaviors 202. Using the grasp geometry 214, the grasper 210 generates a first behavior 202, 202a for the end-effector 126_{H} of the arm 126. The first behavior 202a controls the end-effector 126_{H} of the arm 126 to grasp the handle 26 of the door 20. For example, the grasper 210 controls the arm 126 (i.e., robotic manipulator) of the robot 100 to grasp the handle 26 of the door 20 on a first side of the door 20 that faces the robot 100.

With the handle 26 grasped by the end-effector 126_{H} of the arm 126, the door opening system 200 continues the door opening sequence by communicating the execution of the first behavior 202a to the handle actuator 220. The handle actuator 220 is configured to perform a second behavior 202, 202b where the second behavior 202b refers to actuating the handle 26 of the door 20. The type and/or amount of actuation required by the handle 26 may vary depending on the type of handle 26 that the door 20 has. For instance, the handle 26 may be a lever handle, a doorknob, a handle set, or other known construction for a door handle 26. Generally speaking, actuation of the handle 26 may refer to twisting/turning of the handle 26 some degree of rotation. By turning the handle 26 some degree of rotation, the second behavior 202b may enable the handle 26 to unlatch the door 20 from the frame 24 such that the latching mechanism of the door 20 may not prevent or inhibit the robot 100 from successfully opening the door 20. Some handles 26 may unlatch the door 20 from the frame 24 when actuated in either direction. Other handles 26 may unlatch the door 20 from the frame 24 when actuated in a particular direction (i.e., rotated in one direction rather than another direction). In either case, the handle actuator 220 may be configured to determine which direction to rotate the handle 26 in order to unlatch the door 20 from the frame 24 and to successfully actuate the handle 26 to perform the second behavior 202b.

When the end-effector 126_{H} of the arm 126 successfully actuates the handle 26 unlatching the door 20 from the frame 24, the door opening system 200 continues the door opening sequence by communicating the execution of the second behavior 202b to the door opener 230. The door opener 230 may be configured to perform more than one behavior 202 in the door opening sequence. When the door opener 230 receives an indication that the handle actuator 220 has executed the second behavior 202b, the door opener 230 may first try to understand in which direction the door 20 will open. That is, the door opener 230 is configured to perform a third behavior 202, 202c that detects whether the door 20 opens by swinging in a first direction towards the robot 100 or a second direction away from the robot 100.

In some implementations, to detect which direction the door 20 opens, the door opener 230 is configured to test each opening direction for the door 20 by exerting a pull force on the handle 26 and/or exerting a push force on the handle 26. When the door opener 230 senses less resistance in a particular direction, the door opener 230 determines that the direction with less resistance corresponds to a swing direction for the door 20. In some examples, in order to sense which direction has less resistance, when the door opener 230 exerts a force in that direction, the door opener 230 uses sensor data 134 generated by the sensor system 130 while the door opener 230 exerts the door opening test force in a particular direction. These sensors 132 used by the door opener 230 to determine the direction in which the door 20 opens may be proprioceptive sensors that measure values internal of the robot 100, exteroceptive sensors that gather information external to the robot 100 (e.g., about the robot's relationship to the environment 10), or some combination of both. For example, sensor data 134 from proprioceptive sensors may inform the door opener 230 as to whether a load on one or more actuators of the robot 100 increases or decreases as the door opener 230 exerts a pull force and/or a push force while testing the opening direction of the door 20. Here, the door opener 230 may expect the initial force exerted on the door 20 in the opening direction to be a first magnitude and then to remain constant or to decrease when the door opener 230 is exerting the force in a direction that matches the opening direction for the door 20. In contrast, the door opener 230 may expect the initial force exerted on the door 20 in a direction opposite the opening direction to be a first magnitude and then to increase when the door opener 230 is exerting the force against the opening direction for the door 20. As shown in FIG. 2A, when the door opener 230 executes the third behavior 202c and determines the door opening direction, the door opening system 200 proceeds to either a pull door sequence (e.g., FIG. 2B) or a push door sequence (e.g., FIG. 2C).

Referring to FIG. 2B, after the door opener 230 executes the third behavior 202c and identifies that the door 20 opens in a direction towards the robot 100, the door opening system 200 transitions to a pull sequence to open the door 20. As the door opener 230 initially pulls the door 20 open towards the robot 100, the door 20 swings from a completely or relatively closed state to a partially open state (e.g., between 20 to 40 degrees partially open from the closed state). Here, the completely closed state (also referred to as a closed state) for the door 20 occurs when the door 20 is aligned or coplanar with the walls that transition to the frame 24 of the door 20. In other words, the door 20 is completely closed when the volume of the door 20 occupies an entirety of the frame 24 of the door 20 (i.e., the edges 20e of the door 20 abut the frame 24). In contrast, the door 20 is in a completely open state (also referred to the open state) when the door 20 is perpendicular to a plane spanning the frame 24 of the door 20. Accordingly, the door 20 may swing to any degree between the closed state and the open state such that the swing area SA for the door 20 spans at least a 90 degree arc corresponding to the width of the door 20.

When the pull force that is opening the door 20 pulls the door 20 partially open, the force transferor 240 is configured to perform a fourth behavior 202, 202d that blocks/chaulks the door 20 from closing. By blocking/chaulking the door 20 from closing, the robot 100 may reconfigure the manner in which it is opening the door 20 and allow the robot 100 to avoid a collision with the door 20 as the door 20 swings toward the open state. In other words, if the robot 100 remained at or near its opening stance position, the robot 100 may be at least partially located in the swing area SA of the door 20 and interfere with the opening of the door 20. By blocking the door 20 from closing, the fourth behavior 202d may therefore allow the robot 100 to transfer the force being exerted by the arm 126 to open the door 20 from a pull force to a push force and to move around (e.g., to step around) the door 20 as the arm 126 then pushes the door 20 further open.

In some examples, the robot 100 uses its arm 126 and/or hand member 128_{H} to block the door 20. For example, the door opener 230 may cause the door 20 to at least partially open, and the robot 100 may place its arm 126 and/or hand member 128_{H} on the second side of the door 20 to prevent the door 20 from closing. In some examples, the robot 100 uses one of its feet 124 to block the door 20. For instance, as shown in FIG. 2B, the robot 100 blocks the door 20 with the front foot 124 of the robot 100 that the door 20 encounters first as the door 20 swings open. Stated differently, the robot 100 chaulks the door 20 with the foot 124 closest to the edge 20e of the door 20 opposite the hinges 22 to maintain the door 20 partially open.

In some implementations, the door opening system 200 collaborates with a perception system of the robot 100 in order to identify the edge 20e of the door 20 for the blocking behavior 202d. The perception system of the robot 100 may receive sensor data 134 as the door 20 opens. The sensor data 134 may allow the perception system to generate a voxel map for an area about the robot 100 that includes the door 20 and, more particularly, the edge 20e of the door 20. Since the voxel map, or derivative forms of the voxel map, may identify obstacles about the robot 100 in real-time or near real-time, the perception system therefore may recognize the edge 20e of the door 20 as the edge of a moving obstacle adjacent the robot 100 (e.g., an obstacle located at the end-effector 126_{H} of the arm 126). In this regard, the force transferor 240 of the door opening system 200 may use obstacle information from the perception system to more accurately detect the edge 20e of the door 20 for the blocking behavior 202d than simply using the sensor data 134 without being processed by the perception system. Using the information from the perception system to identify the edge 20e of the door 20, the force transferor 240 then blocks the door 20 by instructing the robot 100 to move the foot 124 of the robot 100 nearest the edge 20e of the door 20 to a position where the inside of that foot 124 contacts or is adjacent to the outside portion of the identified edge 20e for the door 20. For instance, if the door 20 swings open towards the robot 100 from the left side of the robot 100 to the right side of the robot 100 (e.g., the door hinges 22 are on the right side of the door 20), the left front foot 124 of the robot 100 may block the door 20 since the edge 20e of the door 20 first encounters the left front foot 124 when swinging open.

With the foot 124 blocking the door 20 from closing, the force transferor 240 may perform a fifth behavior 202e that releases the door 20 at the end-effector 126_{H}; allowing the door 20 to potentially swing towards the closed state and contact the blocking foot 124 of the robot 100. As illustrated in the example of FIG. 2B, with the end-effector 126_{H} no longer exerting the pull force on the first side of the door 20 that initially pulled open the door 20, the arm 126 of the robot 100 may hook or wrap around the door 20 and exert a force on the second side of the door 20 opposite the first side of the door 20 that continues to move the door 20 to the open state. In addition to blocking the door 20 with the foot 124, this maneuver to transfer force to the second side of the door 20 may hook the arm 126 around the door 20 initially such that a portion of the arm 126 contacts the edge 20e of the door 20 being blocked by the foot 124 and also a portion of the arm 126 contacts the second side of the door 20. For example, as illustrated by FIG. 1A, the arm 126 may include multiple arm joints J_{A} that allow the arm 126 to articulate in different ways. Here, in order to hook the door 20 as the arm 126 transfers the door opening force from the first side of the door 20 to the second side of the door 20, the fourth arm joint J_{A4} may articulate such that the end-effector 128_{H} extends along the second side of the door 20 and the upper member 128_{U} of the arm 126 extends along the edge 20e of the door 20 (i.e., forming an L or hook that contours the intersection of the second side of the door 20 and the edge 20e of the door 20). With this hook configuration, the arm 126 may be able to initially pull the door 20 further open while stepping around the door 20 until the arm 126 can push the door 20 away from the robot 100 with the door opening force. By hooking the door 20, the arm 126 may have more leverage to shift from exerting the door opening force as a pull force to a push force in order to continue opening the door 20 for the robot 100. Additionally or alternatively, more than one arm joint J_{A} enables the arm 126 to hook the door 20. For instance, the sixth joint J_{A6}, as a twist joint, may twist or rotate the upper member 128U about its longitudinal axis such that this rotation allows the fourth joint J_{A4} and/or fifth joint J_{A5} at or near the hand member 128_{H} to rotate and hook the door 20. In other words, an arm joint J_{A} like the sixth arm joint J_{A6} can operate to turn the hand member 128_{H} in a manner that allows the hand member 128_{H} to yaw instead of pitch to hook the door 20.

With continued reference to FIG. 2B, the door opening system 200 communicates the execution of the fifth behavior 202e back to the door opener 230 to allow the door opener 230 to perform a sixth behavior 202, 202f that continues to exert the door opening force on the door 20 to swing the door 20 open. When the door opener 230 receives the communication corresponding to the execution of the fifth behavior 202e, the opening of the door 20 no longer poses a collision risk with the robot 100 since the robot 100 has stepped around the door 20. At this point, the door opener 230 may exert a door opening force that prevents the door 20 from closing to collide with the robot 100 as the robot 100 traverses the open doorway previously occupied by the door 20. In some configurations, the arm 126 continues to exert the door opening force on the door 20 until the door 20 no longer poses a threat to collide with a rear portion of the body 110 of the robot 100 or one or more rear legs 120 of the robot 100. In some examples, a length of the arm 126 dictates when the arm 126 decreases the amount of force being exerted on the second side of the door 20 since the arm 126 may not be long enough to hold the door 20 open until the robot 100 completely traverses the doorway. In some implementations, the arm 126 may reduce the amount of force being exerted on the second side of the door 20, but still function as a block to prevent the door 20 from swinging closed and hitting the robot 100 at a location other than the arm 126.

Referring to FIGS. 2A and 2C, after the door opener 230 executes the third behavior 202c and identifies that the door 20 opens in a direction away from the robot 100, the door opening system 200 transitions to a push sequence to open the door 20. During the push sequence, the door opening system 200 does not need to transfer the door opening force from the first side of the door 20 to the second side of the door 20. Rather, to open the door 20, the door opener 230 may proceed to exert the door opening force on the first side of the door 20 in order to push the door 20 along its swing path to the open state.

When executing a push sequence, the robot 100 may begin to traverse the doorway as the door 20 opens. In some examples, as the robot 100 traverses the doorway, the door opener 230 may control the movement of the robot 100 or collaborate with the control system 170 to coordinate the movement of the robot 100. In order to achieve coordinated actions between the movement of the robot 100 through the doorway and the opening of the door 20, the door opener 230 operates with some operational constraints 232. In some examples, these operational constraints 232 are such that the door opener 230 (i) continues to push the door 20 open while (ii) maintaining the arm 126 (e.g., the end-effector 128_{H}) in contact with the first side of the door 20 (e.g., with the door handle 26), and (iii) maintaining a goal position 234 for the body 110 of the robot 100. Here, the goal position 234 refers to a constraint 232 where the door opener 230 tries to keep the body 110 of the robot (e.g., the center of mass COM of the robot 100) aligned along a centerline CL of the door frame 24 as the robot 100 traverses the doorway. In other words, the door opener 230 aims to maintain a body alignment position along the centerline CL of the door frame 24. By incorporating these constraints 232, the door opener 230 may manage the door opening force as a function of the door angle. Stated differently, since the robot 100 intends to walk through the doorway at some forward velocity, the door opener 230 may control the swing speed of the door 20 to be a function of the forward velocity of the robot 100. For instance, the operator of the robot 100 or autonomous navigation system of the robot 100 has a desired traversal speed across the doorway. Here, the desired door angle becomes a function of the robot's progress through the door 20 (i.e., along the centerline CL) at the desired speed of travel. Moreover, the door opening force exerted by the end-effector 128_{H} is managed by the door opener 230 by determining a deviation or error between the actual door angle and the desired door angle for the robot's speed.

In some examples, by maintaining the body alignment position 234 along the centerline, the door opener 230 is configured to reduce a forward traveling velocity of the COM of the robot 100 if the actual position of the COM of the robot 100 deviates from the goal position 234 (i.e., position along the centerline CL). FIG. 2C illustrates the body alignment position 234 of the robot 100 along the centerline CL as a function of the door angle by depicting a time sequence where the door 20 is initially closed (e.g., shown at 0 degrees), then partially open (e.g., shown at 60 degrees), and then fully open (e.g., shown at 90 degrees). With constraints 232 for the door opener 230, the door opening system 200 enables the robot 100 to traverse the doorway at a gait with a traversal speed proportional to the opening force being exerted on the first side of the door 20. For example, door opener 230 exerts a door opening force that maintains a door 20 swing speed for the door 20 that is equal to the traversal speed of the robot 100.

In some implementations, such as FIG. 2D, the door opening system 200 also includes a recovery manager 250. The recovery manager 250 is configured to coordinate recovery and fallback behaviors 202 when the robot 100 is disturbed during a door opening sequence. With the recovery manager 250, the door opening system 200 is able to prevent the robot 100 from having to entirely restart the door opening sequence to open a door 20. In other words, if the arm 126 was disturbed such that the disturbance to the arm 126 knocked the arm 126 off of the door 20 while the arm 126 was performing the sixth behavior 202f pushing the door 20 open during a pull sequence, the recovery manager 250 may be monitoring the current state of the behaviors 202 and instruct the robot 100 to block the door 20 with its foot 124 before the door 20 completely closes due to a lack of force by the robot 100.

To execute one or more fallback behaviors 202, the recover manager 250 may identify a current parameter state 252 when the disturbance occurs and compare this current parameter state 252 to parameters 254a-n that are associated with the behaviors 202a-n performed by the components 210, 220, 230, 240 of the door opening system 200. In this approach, the recovery manager 250 may cycle through each behavior 202 to identify whether the current parameter state 252 matches parameters 254 associated with a particular behavior 202. Here, when a match occurs, this means that door opening sequence does not necessarily have to restart entirely, but rather may fall back to perform the behavior 202 associated with the matching parameters 254. In other words, the recovery manager 250 may treat each behavior 202 as its own domain or sub-sequence where each behavior 202 begins with a particular set of parameters 254 that enable that behavior 202 to occur. Accordingly, when a particular behavior 202 executes, it delivers, as its output, behavior parameters 254 that enable the next behavior 202 in the door opening sequence to occur. In this respect, if the recovery manager 250 identifies that the current parameter state of the robot 100 resulting from the disturbance matches behavior parameters 254 that enable a behavior 202 to occur, the recovery manager 250 may instruct the robot 100 to continue the door opening sequence at that behavior 202. This technique may allow the recovery manager 250 to take a top down approach where the recover manager 250 attempts to recover the door opening sequence at a behavior 202 near completion of the door opening sequence and work backwards through the behaviors 202 to an initial behavior 202 that begins the door opening sequence. For example, FIG. 2D illustrates the recovery manager 250 performing the behavior recovery process by initially determining whether the fifth behavior parameters 254e match the current parameter state 252.

In some configurations, the door opening system 200 operates while other various systems of the robot 100 are also performing. One such example of this parallel operation is that the door opening sequence may be performed in more complicated areas such as when a door 20 occurs at the top of a staircase landing. In this situation, the initial opening stance position of the robot 100 is not one where all feet 124 of the robot 100 are in contact with the same ground plane, but rather the feet 124 of the robot 100 may be in contact with ground planes at different heights. For instance, when the door 20 is located at the top of the stairs, a size of the robot 100 (e.g., length of the body 110 of the robot 100) may prohibit the robot 100 from standing with all four legs 120 on the same ground plane. Instead, one or more legs 120 (e.g., the rear or hind legs) may be located at a lower elevation (e.g., on a lower stair) than the other legs 120 (e.g., the front legs). In this scenario, traversing the swing area SA to walk through the door 20 may entail one or more legs 120 to also traverse the elevated terrain of the remaining stairs. Since a perception system or navigational system of the robot 100 may be operating while the door opening sequence occurs, the robot's other systems will successfully navigate the legs 120 to traverse the remainder of the steps while the robot 100 is also able to open the door 20 and walk through the doorway.

In some configurations, the door opening system 200 includes or is coordinating with an obstacle avoider 260 during the door opening sequence. An obstacle avoider 260 enables the robot 100 to recognize and/or avoid obstacles 30 that may be present in an area around the door 20 (e.g., in the swing area SA). Furthermore, the obstacle avoider 260 may be configured to integrate with the functionality of the door opening system 200. As previously stated, the door opening system 200 may be operating in conjunction with a perception system or a mapping system of the robot 100. The perception system may function by generating one or more voxel maps for an area about the robot 100 (e.g., a three meter near-field area). Here, a voxel map generated by the perception system may be generated from sensor data 134 and from some version of an occupancy grid that classifies or categorizes two or three-dimensional cells of the grid with various characteristics. For example, each cell may have an associated height, a classification (e.g., above-ground obstacle (e.g., a chair), below-ground obstacle (e.g., a hole or trench), a traversable obstacle (e.g., has a height that the robot 100 can step over), etc.), or other characteristics defined at least in some manner based on sensor data 134 collected by the robot 100. When the door opening system 200 operates in conjunction with the perception system, this integration may be coordinated by way of the obstacle avoider 260. For instance, the obstacle avoider 260 may allow the door opening system 200 to recognize the edge 20e of the door 20 as the door 20 is moving (e.g., opening) by detecting the door 20 as occupying some space (e.g., some set of cells) in a voxel-based map. In this respect, as the door 20 moves, the perception system perceives that new cells are being occupied (e.g., cells where the door 20 has swung into) and previously occupied cells are becoming unoccupied (e.g., the door 20 has swung to a position that no longer occupies those cells). Since the obstacle avoider 260 is integrated with the door opening system 200, the obstacle avoider 260 is able to recognize that the cells are changing states in response to behaviors 202 currently being executed by the door opening system 200 (e.g., opening the door 20).

In some implementations, the obstacle avoider 260 leverages the knowledge of the behaviors 202 currently being executed by the door opening system 200 to detect obstacles 30 such as blind obstacles or door-obstructed obstacles. In other words, in reality, the robot 100 may encounter an obstacle 30 on the other side of the door 20 that was not perceivable by the robot 100 when the door 20 was closed or partially closed obstructing the robot's view of the obstacle 30. Here, an obstacle 30 that the robot 100 is unable to perceive at some stage of the door opening sequence that may inhibit the robot's ability to successfully traverse the door 20 and doorway is considered a blind obstacle. For instance, the door 20 is a basement door and the robot 100 is traveling from the basement to a first level. Here, a chair from a kitchen table may be partially obstructing the doorway, but the robot 100 is unable to see this obstacle 30 because the obstacle 30 is on the other side of the closed basement door (i.e., the robot's sensor field of view is obstructed by the door 20). Here, although a perception system (e.g., a voxel-based system) can identify cell occupancy in real-time or near real-time for the robot 100, the fact that door 20 will be moving and the chair is near the door 20 may cause additional challenges. That is, the occupancy grid may appear to have several occupied cells and cells changing occupied/unoccupied status causing a perception system to potentially perceive that more obstacles 30 exist within a field of view (e.g., akin to perception noise). To overcome this issue, the obstacle avoider 260 leverages its knowledge of the behaviors 202 currently being executed by the door opening system 200 to enhance its ability to classify non-door objects 40. For instance, the obstacle avoider 260 clears the voxel region 262 of a voxel map around where it knows the door 20 (e.g., based on the behaviors 202) to be located. As shown in FIG. 2E, the obstacle avoider 260 may receive an indication that the door opening system 200 has blocked the door 20 (e.g., the fourth behavior 202d) and, in response to this indication, the obstacle avoider 260 clears a voxel region 262 of a voxel map in an area around the door 20. Here, although FIG. 2E shows the obstacle avoider 260 clearing the voxel region 262 in response to the blocking behavior 202d, the obstacle avoider 260 may clear the voxel region 262 about the robot 100 at one or more other stages of the door opening sequence. By clearing the voxel region 262 about the door 20, the obstacle avoider 260 is able to focus on non-door objects 40 (e.g., such as the box 40 shown in FIG. 2E) that may be present in the perception field of the robot 100 and/or to determine whether these non-door objects 40 pose an issue for the robot 100 (e.g., are obstacles 30 that need to be avoided). In addition to focusing the obstacle avoider 260 on non-door objects 40 that may be obstacles 30, clearing the voxel region 262 about the door 20 may also enable the perception system to avoid declaring or communicating that the door 20 itself is an obstacle 30 while the door opening system 200 is performing behaviors 202 to account for or avoid the door 20. In this respect, the obstacle avoider 260 working with the door opening system 200 prevents a perception system or some other obstacle aware system from introducing other behaviors or behavior recommendations that could compromise the success of the door opening sequence. Otherwise, the robot 100 may be afraid of hitting the door 20 in the sense that other built-in obstacle avoidance systems are communicating to the robot 100 that the door 20 is an obstacle 30 that should be avoided.

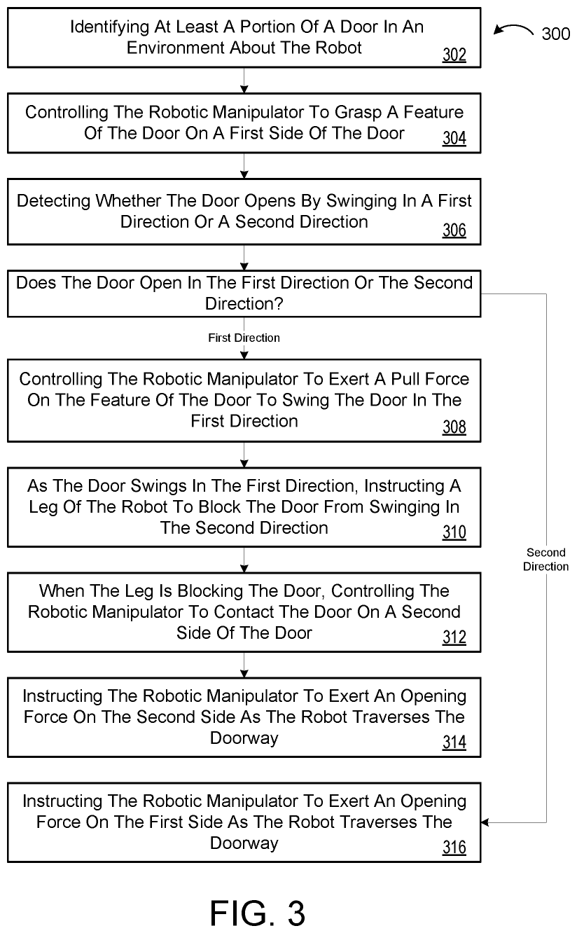

FIG. 3 is a flowchart of an example arrangement of operations for a method 300 of controlling the robot 100 to open the door 20. The method 300 may be a computer implemented method executed by data processing hardware of the robot 100, which causes the data processing hardware to perform operations. At operation 302, the method 300 includes identifying at least a portion of a door 20 within an environment 10 about the robot 100. The robot 100 includes the robotic manipulator 126. At operation 304, the method 300 includes controlling the robotic manipulator 126 to grasp a feature 26 of the door 20 on a first side of the door 20 facing the robot 100. At operation 306, the method 300 includes detecting whether the door 20 opens by swinging in a first direction toward the robot 100 or a second direction away from the robot 100. When the door 20 opens by swinging in the first direction toward the robot 100, the method 300 includes, at operation 308, controlling the robotic manipulator 126 to exert a pull force on the feature 26 of the door 20 to swing the door in the first direction from a first position to a second position. The method 300 further includes, at operation 310, and as the door swings in the first direction from the first position to the second position, instructing a leg 120 of the robot 100 to move to a position that blocks the door 20 from swinging in the second direction toward the first position. When the leg 120 is located in the position that blocks the door 20 from swinging in the second direction, the method 300 includes at operation 312, controlling the robotic manipulator 126 to contact the door 20 on a second side of the door 20 opposite the first side of the door. The method 300 further includes, at operation 314, instructing the robotic manipulator 126 to exert a door opening force on the second side of the door 20 as the robot 100 traverses a doorway corresponding to the door 20. When the door 20 opens by swinging in the second direction away from the robot 100, the method 300 includes, at operation 316, instructing the robotic manipulator 126 to exert the door opening force on the first side of the door 20 as the robot 100 traverses the doorway.

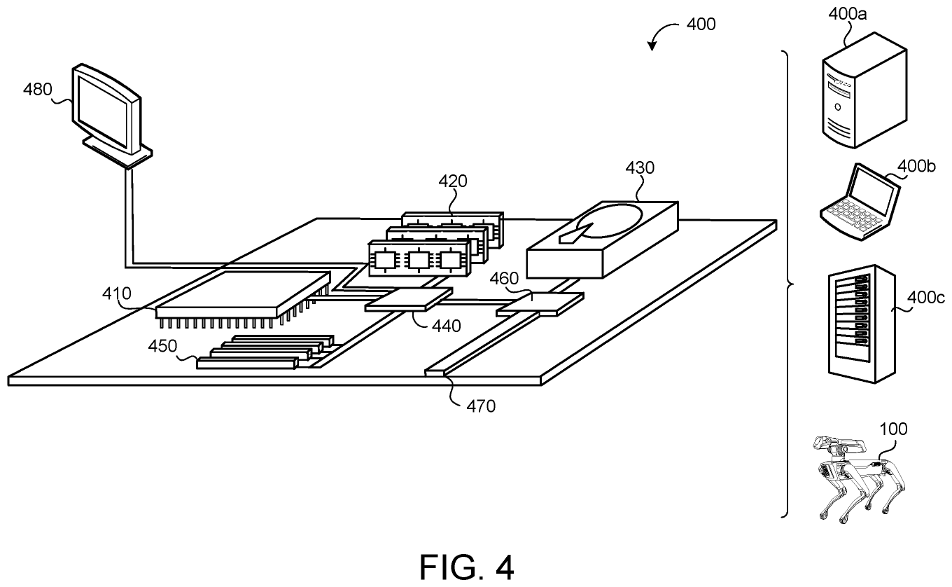

FIG. 4 is schematic view of an example computing device 400 that may be used to implement the systems and methods described in this document. The computing device 400 is intended to represent various forms of digital computers, such as laptops, desktops, workstations, personal digital assistants, servers, blade servers, mainframes, and other appropriate computers. The components shown here, their connections and relationships, and their functions, are meant to be exemplary only, and are not meant to limit implementations of the inventions described and/or claimed in this document.

The computing device 400 includes a processor 410 (e.g., data processing hardware 142, 162), memory 420 (e.g., memory hardware 144, 164), a storage device 430, a high-speed interface/controller 440 connecting to the memory 420 and high-speed expansion ports 450, and a low speed interface/controller 460 connecting to a low speed bus 470 and a storage device 430. Each of the components 410, 420, 430, 440, 450, and 460, are interconnected using various busses, and may be mounted on a common motherboard or in other manners as appropriate. The processor 410 can process instructions for execution within the computing device 400, including instructions stored in the memory 420 or on the storage device 430 to display graphical information for a graphical user interface (GUI) on an external input/output device, such as display 480 coupled to high speed interface 440. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 420 stores information non-transitorily within the computing device 400. The memory 420 may be a computer-readable medium, a volatile memory unit(s), or non-volatile memory unit(s). The non-transitory memory 420 may be physical devices used to store programs (e.g., sequences of instructions) or data (e.g., program state information) on a temporary or permanent basis for use by the computing device 400. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

The storage device 430 is capable of providing mass storage for the computing device 400. In some implementations, the storage device 430 is a computer-readable medium. In various different implementations, the storage device 430 may be a floppy disk device, a hard disk device, an optical disk device, or a tape device, a flash memory or other similar solid state memory device, or an array of devices, including devices in a storage area network or other configurations. In additional implementations, a computer program product is tangibly embodied in an information carrier. The computer program product contains instructions that, when executed, perform one or more methods, such as those described above. The information carrier is a computer- or machine-readable medium, such as the memory 420, the storage device 430, or memory on processor 410.

The high speed controller 440 manages bandwidth-intensive operations for the computing device 400, while the low speed controller 460 manages lower bandwidth-intensive operations. Such allocation of duties is exemplary only. In some implementations, the high-speed controller 440 is coupled to the memory 420, the display 480 (e.g., through a graphics processor or accelerator), and to the high-speed expansion ports 450, which may accept various expansion cards (not shown). In some implementations, the low-speed controller 460 is coupled to the storage device 430 and a low-speed expansion port 470. The low-speed expansion port 470, which may include various communication ports (e.g., USB, Bluetooth, Ethernet, wireless Ethernet), may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 400a or multiple times in a group of such servers 400a, as a laptop computer 400b, or as part of a rack server system 400c.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

The processes and logic flows described in this specification can be performed by one or more programmable processors executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

A number of implementations have been described. Nevertheless, it will be understood that various modifications may be made without departing from the spirit and scope of the disclosure. Accordingly, other implementations are within the scope of the following claims.

What is claimed is:

1. A computer-implemented method when executed by data processing hardware of a robot causes the data processing hardware to perform operations comprising:
identifying at least a portion of a door within an environment about the robot, the robot comprising a robotic manipulator;
controlling the robotic manipulator to grasp a feature of the door on a first side of the door facing the robot;
detecting whether the door opens by swinging in a first direction toward the robot or a second direction away from the robot;
when the door opens by swinging in the first direction toward the robot:
controlling the robotic manipulator to exert a pull force on the feature of the door to swing the door in the first direction from a first position to a second position;
as the door swings in the first direction from the first position to the second position, instructing a leg of the robot to move to a position that blocks the door from swinging in the second direction toward the first position;
when the leg is located in the position that blocks the door from swinging in the second direction, controlling the robotic manipulator to contact the door on a second side of the door opposite the first side of the door; and
instructing the robotic manipulator to exert a door opening force on the second side of the door as the robot traverses a doorway corresponding to the door; and
when the door opens by swinging in the second direction away from the robot, instructing the robotic manipulator to exert the door opening force on the first side of the door as the robot traverses the doorway.

2. The method of claim 1, wherein the operations further comprise, when the door opens by swinging in the second direction away from the robot, instructing the robot to traverse the doorway at a gait with a traversal speed, whereby the traversal speed is based on the door opening force being exerted on the first side of the door.

3. The method of claim 2, wherein the traversal speed is based on an opening speed of the door caused by the door opening force being exerted on the first side of the door.

4. The method of claim 1, wherein the operations further comprise, when the door opens by swinging in the second direction away from the robot, maintaining a body alignment position for the robot along a centerline of the doorway corresponding to the door as the robot traverses the doorway.

5. The method of claim 1, wherein instructing the robotic manipulator to exert the door opening force on the first side of the door as the robot traverses a doorway corresponding to the door comprises controlling the door opening force as a function of an angle of the door with respect to an orientation of the robot while the robot traverses the doorway.

6. The method of claim 1, wherein the robot is a quadruped.

7. The method of claim 1, the operations further comprise instructing the robotic manipulator to cease exerting the door opening force when the robot clears a swing area associated with the door.

8. The method of claim 1, wherein the operations further comprise:
receiving proprioceptive sensor data for the robot; and
determining the door opening force based on the received proprioceptive sensor data.

9. The method of claim 1, wherein controlling the robotic manipulator to contact the door on the second side of the door opposite the first side of the door further comprises positioning the robotic manipulator to wrap around an edge of the door.

10. The method of claim 9, wherein positioning the robotic manipulator to wrap around the edge of the door comprises positioning a first portion of the robotic manipulator along the edge of the door and positioning a second portion of the robotic manipulator to extend along the second side of the door.

11. A robot comprising:
a body;
two or more legs coupled to the body;
a robotic manipulator coupled to the body;
data processing hardware; and
memory hardware in communication with the data processing hardware, the memory hardware storing instructions that when executed on the data processing hardware cause the data processing hardware to perform operations comprising:
identifying a door within an environment about the robot;
controlling the robotic manipulator to grasp a feature of the door on a first side of the door facing the robot;
detecting whether the door opens by swinging in a first direction toward the robot or a second direction away from the robot;
when the door opens by swinging in the first direction towards the robot:
controlling the robotic manipulator to exert a pull force on the feature of the door to swing the door in the first direction from a first position to a second position;
as the door swings in the first direction from the first position to the second position, instructing a respective leg among the two or more legs of the robot to move to a position that blocks the door from swinging in the second direction;
when the respective leg is located in the position that blocks the door from closing, controlling the robotic manipulator to contact the door on a second side of the door opposite the first side of the door; and
instructing the robotic manipulator to exert a door opening force on the second side of the door as the robot traverses a doorway corresponding to the door; and
when the door opens by swinging in the second direction away from the robot, instructing the robotic manipulator to exert the door opening force on the first side of the door as the robot traverses the doorway.

12. The robot of claim 11, wherein the operations further comprise, when the door opens by swinging in the second direction away from the robot, instructing the robot to traverse the doorway at a gait with a traversal speed, whereby the traversal speed is based on the door opening force being exerted on the first side of the door.

13. The robot of claim 12, wherein the traversal speed is based on an opening speed of the door caused by the door opening force being exerted on the first side of the door.

14. The robot of claim 11, wherein the operations further comprise, when the door opens by swinging in the second direction away from the robot, maintaining a body alignment position for the robot along a centerline of the doorway as the robot traverses the doorway.

15. The robot of claim 11, wherein instructing the robotic manipulator to exert the door opening force on the first side of the door as the robot traverses a doorway corresponding to the door comprises controlling the door opening force as a function of an angle of the door with respect to an orientation of the robot while the robot traverses the doorway.

16. The robot of claim 11, wherein the two or more legs comprise four legs.

17. The robot of claim 11, wherein the operations further comprise instructing the robotic manipulator to cease exerting the door opening force when the robot clears a swing area associated with the door.

18. The robot of claim 11, wherein the operations further comprise:
receiving proprioceptive sensor data for the robot; and
determining the door opening force based on the received proprioceptive sensor data.

19. The robot of claim 11, wherein controlling the robotic manipulator to contact the door on the second side of the door opposite the first side of the door further comprises positioning the robotic manipulator to wrap around an edge of the door.

20. The robot of claim 19, wherein positioning the robotic manipulator to wrap around the edge of the door comprises positioning a first portion of the robotic manipulator along the edge of the door and positioning a second portion of the robotic manipulator to extend along the second side of the door.
